(19) United States
(12) Patent Application Publication
(10) Pub. No.: US 2010/0231502 A1
(43) Pub. Date: Sep. 16, 2010

(54) Liquid crystal display device and method of controlling powering on of the same

(75) Inventor: Tatsumasa Kondo, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/660,760

(22) Filed: Mar. 4, 2010

(30) Foreign Application Priority Data
Mar. 13, 2009 (JP) P2009-060445

(51) Int. Cl. G09G 3/36

(52) U.S. Cl. 345/102

(57) ABSTRACT

A liquid-crystal display device including a liquid-crystal display panel, a panel driver configured to drive the liquid-crystal display panel, a backlight section configured to be arranged on the rear face of the liquid-crystal display panel, a backlight driver configured to drive the backlight section, and a control section configured to control the panel driver and the backlight driver. When the liquid-crystal display device is powered on, the control section controls the backlight driver so that the backlight section is put into a backlight-on state in which the backlight section illuminates the liquid-crystal panel from the rear face. Then, after the elapse of a predetermined time from the setting of the backlight-on state, the control section controls the panel driver so that the liquid-crystal display panel is put into an image-display-on state in which the liquid-crystal display panel displays the image.

### BACKGROUND OF THE INVENTION

1. Field of the Invention

The invention relates to a liquid crystal display device and a method of controlling powering on of the liquid crystal display device. In addition, the invention relates to a liquid crystal display device in which a backlight section is arranged on the rear face of the liquid crystal display panel.

2. Description of the Related Art

Recently, liquid crystal display devices have been put to practical use and used in many fields as relatively large-size display devices used outdoors. Liquid crystal display devices are sometimes put in a cryogenic environment, for example, at temperatures below minus 20 degrees Celsius. In this case, since a liquid crystal display panel does not function normally for a predetermined time after powering on, there is a problem that an image is displayed in a patchy fashion.

For example, according to a patent document 1 (see Japanese Unexamined Patent Application Publication No. 2001-350135), a planar heater corresponding to the liquid crystal display panel, a so-called sheet heater, is provided so as to prevent the liquid crystal display panel from being cold.

### SUMMARY OF THE INVENTION

According to patent document 1, since the sheet heater is provided between the liquid crystal display panel and a backlight section in the liquid crystal display device for example, the structure becomes complicated. Then, the complicated structure increases the cost of the liquid crystal display device and the power consumption thereof.

Therefore, it is desirable to prevent the structure of the liquid crystal display device from becoming complicated and display a favorable image even in a low-temperature environment.

According to an embodiment of the present invention, there is provided a liquid crystal display device including:

a liquid crystal display panel;

a panel-driving section configured to drive the liquid crystal display panel so that the liquid crystal display panel displays an image;

a backlight section configured to be arranged on the rear face of the liquid crystal display panel;

a backlight-driving section configured to drive the backlight section so that the backlight section illuminates the liquid crystal panel from the rear face; and

a control section configured to control the operations of the panel-driving section and the backlight-driving section;

wherein when the liquid crystal display device is powered on, the control section controls the backlight-driving section so that the backlight section is put into a backlight-on state in which the backlight section illuminates the liquid crystal panel from the rear face; and

after the elapse of a predetermined time from the setting of the backlight-on state, the control section controls the panel-driving section so that the liquid crystal display panel is put into an image-display-on state in which the liquid crystal display panel displays the image.

According to an embodiment of the present invention, when the liquid crystal display device is powered on, first the backlight-driving section is controlled so that the backlight section is put into a backlight-on state in which the backlight section illuminates the liquid crystal panel from the rear face thereof. Then, after the elapse of a predetermined time from the setting of the backlight-on state, the panel-driving section is controlled so that the liquid crystal display panel is put into an image-display-on state in which the liquid crystal display panel displays the image.

In the backlight-on state, the liquid crystal display panel is warmed up with heat generated by the backlight section. Therefore, for example even in a low-temperature environment, after the elapse of the predetermined time from the setting of the backlight-on state, the temperature of the liquid crystal display panel reaches a temperature at which the liquid crystal display panel functions normally. Accordingly, when the image-display-on state is set after the elapse of the predetermined time from the setting of the backlight-on state, a favorable image is displayed while an image is not displayed in a patchy fashion.

For example, the predetermined time is set by a user's operating a user operation section. In this case, the user can arbitrarily set the length of the predetermined time according to an ambient temperature. Accordingly, for example, in a season when an ambient temperature is high, the length of the predetermined time can be set to a short time or zero. Therefore, a waiting time before an image is displayed from the time of powering on can be shortened.

In addition, for example, the predetermined time is set to a time it takes from the setting of the backlight-on state for the temperature of the liquid crystal display panel to become higher than or equal to a predetermined value, the temperature being detected by a temperature sensor. In this case, when a temperature at which the liquid crystal display panel functions normally is set as the predetermined value, the temperature of the crystal display panel reaches the temperature, at which the liquid crystal display panel can function normally, at the time when the image-display-on state is set. Therefore, at the time when the image-display-on state is set, a favorable image is displayed on the liquid crystal display panel while an image is not displayed in a patchy fashion. In addition, in the case that the image-display-on state is set at the time when the temperature of the liquid crystal display panel becomes higher than or equal to the predetermined value after the backlight-on state is set, a useless waiting time can be eliminated.

According to an embodiment of the present invention, there may be provided the liquid crystal display device further including:

a user operation section configured to be used by a user so as to set a warm-up mode,

wherein when the warm-up mode is set by the user operation section upon powering on, the control section controls the backlight-driving section so that the backlight section is put into the backlight-on state in which the backlight section illuminates the liquid crystal panel from the rear face; and

after the elapse of the predetermined time from the setting of the backlight-on state, the control section controls the panel-driving section so that the liquid crystal display panel is put into the image-display-on state in which the liquid crystal display panel displays the image.

For example, when on powering-on the warm-up mode is not set by the user operation section, the control section may control the panel-driving section so that the liquid crystal display panel is put into the image-display-on state, in which the liquid crystal display panel displays the image, and control the backlight-driving section so that the backlight section is put into the backlight-on state in which the backlight section illuminates the liquid crystal panel from the rear face.

In this case, in a season such as winter when an ambient temperature is low, as a result of the user setting the warm-up mode, an image is prevented from being displayed in a patchy fashion. In addition, in another season when an ambient temperature is high, the user does not set the warm-up mode. Therefore, a waiting time before an image is displayed from the time of powering on can be shortened.

In addition, for example, according to an embodiment of the present invention,

after on powering-on the control section may control the panel-driving section so that the liquid crystal display panel is put into the image-display-on state in which the liquid crystal display panel displays the image, the control section determines whether or not the warm-up mode is set by the user operation section;

when the warm-up mode is set by the user operation section, the control section may control the panel-driving section so that the liquid crystal display panel is put into an image-mute-on state in which the liquid crystal display panel does not display the image before controlling the backlight-driving section so that the backlight section is put into the backlight-on state in which the backlight section illuminates the liquid crystal panel from the rear face;

after the elapse of the predetermined time from the setting of the backlight-on state, the control section may control the panel-driving section so that the image-mute-on state is cancelled and the liquid crystal display panel is put into the image-display-on state in which the liquid crystal display panel displays the image; and

when the warm-up mode is not set by the user operation section, the control section may control the backlight-driving section so that the backlight section is put into the backlight-on state in which the backlight section illuminates the liquid crystal panel from the rear face.

In this case, when the warm-up mode is set by the user operation section, the image-display-on state can be set by cancelling the image-mute-on state after the elapse of the predetermined time from the setting of the backlight-on state. Namely, the liquid crystal display panel can shift to the image-display-on state without setting various settings (such as settings of magnification and filtering) in the panel-driving section. Therefore, an image which is out of synchronization is prevented from being displayed on the liquid crystal display panel.

In addition, according to an embodiment of the present invention, for example, when the warm-up mode is set by the user operation section upon powering on,

after the elapse of the predetermined time from the setting of the backlight-on state, the control section may control the backlight-driving section so that the backlight section is put into the backlight-off state in which the backlight section does not illuminate the liquid crystal panel before controlling the panel-driving section so that the liquid crystal display panel is put into the image-display-on state in which the liquid crystal display panel displays the image; and

after the control section controls the panel-driving section so that the liquid crystal display panel is put into the image-display-on state in which the liquid crystal display panel displays the image, the control section may control the backlight-driving section so that the backlight section is put into the backlight-on state in which the backlight section illuminates the liquid crystal panel from the rear face.

In this case, when the warm-up mode is set by the user operation section, the backlight section is put into the backlight-off state once after the elapse of the predetermined time from the setting of the backlight-on state. After that, the image-display-on state is set, and furthermore the backlight-on state is set again. While various settings (such as settings of magnification and filtering) in the panel-driving section are set so that the image-display-on state is set, the backlight-off state is set at this time. Therefore, an image which is out of synchronization is prevented from being displayed on the liquid crystal display panel.

In addition, according to an embodiment of the present invention, for example,

the liquid crystal display device is put into a power-on state by various types of power-on operations; and

the warm-up mode set by the user operation section may be a first warm-up mode available upon powering-on performed by any one of the various types of power-on operations or a second warm-up mode available upon powering-on performed by a specific one of the various types of power-on operations.

In this case, when the first warm-up mode is set, first the backlight-on state is set upon powering-on performed by any one of the various types of power-on operations. Then, the image-display-on state can be set after the elapse of the predetermined time from the setting of the backlight-on state. In addition, when the second warm-up mode is set, first the backlight-on state is set upon powering-on performed by a specific one, such as a power-on operation based on a timer for example, of the various types of power-on operations. Then, the image-display-on state can be set after the elapse of the predetermined time from the setting of the backlight-on state.

In addition, according to an embodiment of the present invention, for example, the backlight section may include a plurality of fluorescent tubes, and the plurality of fluorescent tubes may be evenly arranged on the rear face of the liquid crystal display panel. In this case, the whole surface of the liquid crystal display panel can be warmed up efficiently and in a short time with heat generated by the plurality of fluorescent tubes in the backlight section.

According to an embodiment of the present invention, the backlight-on state is set at the time of powering on. After that, the image-display-on state is set after the elapse of the predetermined time from the setting of the backlight-on state. Therefore, the structure of the liquid crystal display device can be prevented from becoming complicated and a favorable image is displayed even in a low-temperature environment.

### BRIEF DESCRIPTION OF THE DRAWINGS

FIG. 1A is a cross-section schematic diagram illustrating an example of a configuration of a liquid crystal display device according to an embodiment of the present invention;

FIG. 1B is a plane schematic diagram illustrating an example of a configuration of a backlight unit included in the liquid crystal display device;

FIG. 2 is a block diagram illustrating an example of a circuit configuration of the liquid crystal display device;

FIG. 3 is a flowchart illustrating an example of a control operation performed at the time of powering on in a control section;

FIG. 4 is a diagram showing an example of a GUI screen displayed on a display panel when a setting menu of a warm-up mode is selected;

FIG. 5 is a flowchart illustrating another example of a control operation performed at the time of powering on in the control section;

FIG. 6 is a flowchart illustrating another example of a control operation performed at the time of powering on in the control section;

FIG. 7 is a cross-section schematic diagram illustrating another example of a configuration of the liquid crystal display device;

FIG. 8 is a block diagram illustrating another example of a circuit configuration of the liquid crystal display device;

FIG. 9 is a flowchart illustrating another example of a control operation performed at the time of powering on in the control section; and

FIG. 10 is a diagram showing an example of a GUI screen displayed on the liquid crystal display panel when setting menu of a first warm-up mode and a second warm-up mode is selected.

### DESCRIPTION OF THE PREFERRED EMBODIMENTS

Hereinafter, preferred embodiments of the present invention will be described with reference to figures. In addition, the preferred embodiments will be described in the below sequence.

1. an embodiment

2. a modified embodiment

### 1. Embodiment

### [Example of Configuration of Liquid Crystal Display Device]

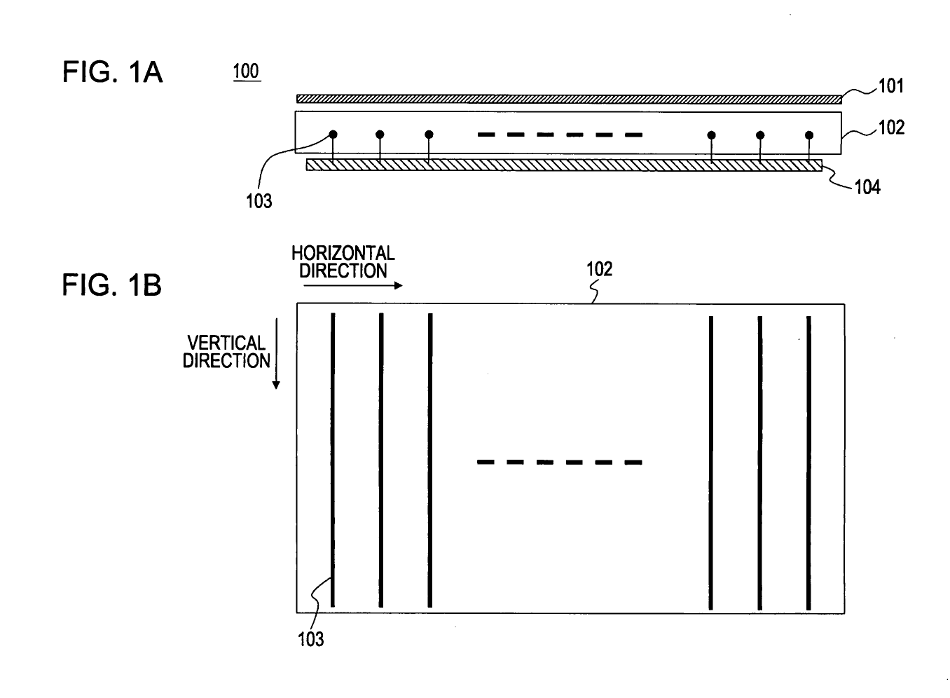

FIG. 1A is a cross-section schematic diagram illustrating an example of a configuration of a liquid crystal display device 100 according to an embodiment of the present invention. In the liquid crystal display device 100, a backlight unit 102 is arranged on the rear face of a liquid crystal display panel (LCD: Liquid Crystal Display) 101. The backlight unit 102 includes a plurality of fluorescent tubes, namely a plurality of cold cathode fluorescent lamps (CCFLs) 103 in the embodiment. The plurality of cold cathode fluorescent lamps 103 are driven by an inverter, not shown in FIG. 1A, arranged on a inverter board 104. The backlight unit 102 is included in the backlight section.

FIG. 1B is a plane schematic diagram illustrating an example of a configuration of the backlight unit 102. As described above, the backlight unit 102 includes the plurality of cold cathode fluorescent lamps 103. The plurality of cold cathode fluorescent lamps 103 are evenly arranged on the rear face of the crystal display panel 101. In addition, in the embodiment, while the cold cathode fluorescent lamps 103 are arranged so that the longitudinal direction thereof corresponds to a vertical direction as shown in FIG. 1B, the cold cathode fluorescent lamps 103 may be arranged so that the longitudinal direction thereof corresponds to a horizontal direction.

### [Example of Circuit Configuration of Liquid Crystal Display Device]

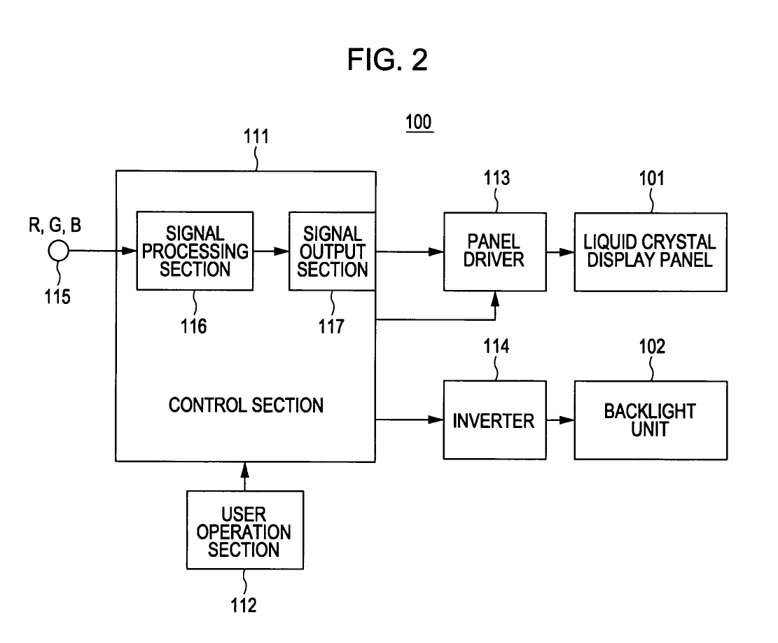

FIG. 2 is a block diagram illustrating an example of a circuit configuration of the liquid crystal display device 100 according to the embodiment. The liquid crystal display device 10 includes a control section 111, a user operation section 112, a panel driver 113, the liquid crystal display panel 101, an inverter 114, the backlight unit 102, and an image-signal input terminal 115.

The control section 111 includes a microcomputer not shown in FIG. 2, a signal processing section 116, and a signal output section 117. The control section 111 controls the operations of the panel driver 113 and the inverter 114 in addition to the signal processing section 116 and the signal output section 117, both of which are included in the control section 111. The signal processing section 116 performs various kinds of processing on an image signal input to the image-signal input terminal 115, namely primary color signals, R, G, and B, of red, green, and blue in the embodiment. For example, the signal processing section 116 performs image-magnification processing, filtering processing used for image-quality adjustment, luminance-adjustment processing, color-adjustment processing, gamma-correction processing, and superimposition processing used for signals displayed on a graphical user interface (GUI) screen.

The signal output section 117 outputs an image signal to the panel driver 113. In an image-mute-off state, the signal output section 117 outputs an image signal obtained in the signal processing section 116 to the panel driver 113. In addition, in an image-mute-on state, the signal output section 117 outputs an image signal used to display a black image to the panel driver 113 as an alternate signal to the image signal obtained in the signal processing section 116.

The user operation section 112 is included in a user interface and connected to the control section 111. The user operation section 112 includes keys, buttons, and a dial, which are arranged on a chassis not shown in FIG. 2, or a transmitter and a receiver which are provided in a remote-control device. A user can set and perform various kinds of settings and operations by operating the user operation section 112. For example, by using the user operation section 112, the user can perform a power-on operation, set a setting of a warm-up mode, to be described below, and set a setting of a time from the setting of a backlight-on state in the warm-up mode to an image-display-on state.

On the basis of image signals (R, G, B) supplied from the signal output section 117 in the control section 111, the panel driver 113 drives the liquid crystal display panel 101 so that the liquid crystal display panel 101 displays an image. The operation of the panel driver 113 is controlled by the above-mentioned control section 111. The signal processing section 116 and the signal output section 117 in the above-mentioned control section 111 and the panel driver 113 are included in a panel-driving section used to display an image on the liquid crystal display panel 101.

The inverter 114 drives the backlight unit 102 so that the backlight unit 102 illuminates the liquid crystal display panel 101 from the rear face thereof. Namely, the inverter 114 supplies electrical power to the plurality of cold cathode fluorescent lamps 103 included in the backlight unit 102 so that the cold cathode fluorescent lamps 103 are lighted. The inverter 114 is included in a backlight-driving section.

### [Example of Control of Powering On]

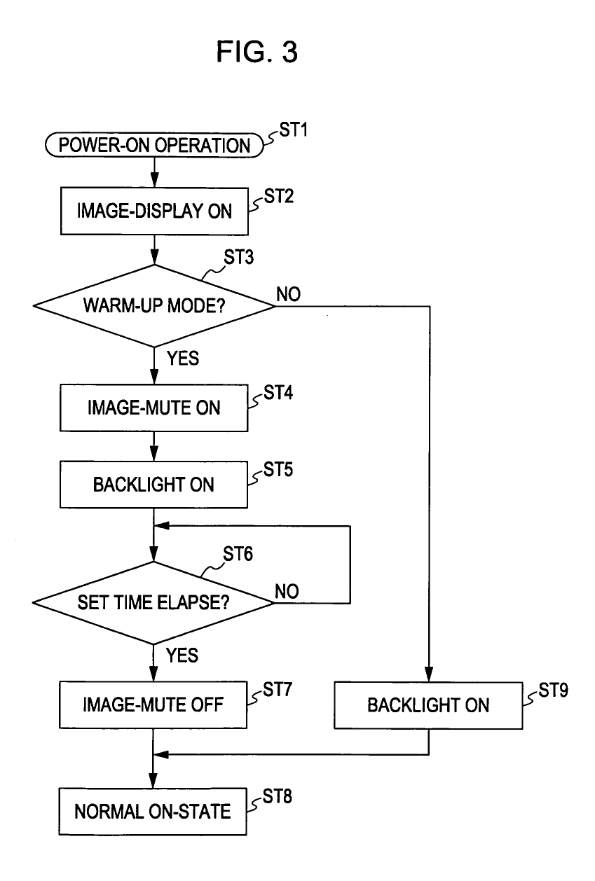

Next, an example of a control operation performed at the time of powering on in the control section 111 will be described with reference to a flowchart shown in FIG. 3. In addition, it is assumed that image signals (R, G, B) are input to the image-signal input terminal 115.

For example, when a power-on operation is performed by using the user operation section 112, the control section 111 starts a control operation in Step ST1. Then, the control operation shifts to processing in Step ST2. In Step ST2, the control section 111 controls the signal processing section 116 and the signal output section 117. Furthermore, the control section 111 puts the panel driver 113 into an operational state and sets the image-display-on state.

In this case, the control section 111 sets various settings (such as settings of magnification and filtering) in the signal processing section 116. In addition, the control section 111 changes the image-mute from an on-state to an off-state and has an image signal supplied to the panel driver 113, the image signal being output from the processing section 116. Accordingly, the image-display-on state in which the liquid crystal display panel 101 displays an image is set. However, at this time, the backlight-on state in which the respective cold cathode fluorescent lamps 103 in the backlight unit 102 are lighted is not set. Therefore, an image displayed on the liquid crystal display panel 101 is actually invisible. In addition, in the image-mute-on state, an entirely black image signal is supplied from the control section 111 to the panel driver 113. Then, the liquid crystal display panel 101 practically does not display an image.

Next, in Step ST3, the control section 111 determines whether or not the warm-up mode is set. The user can perform the setting of the warm-up mode in advance by using a setting menu.

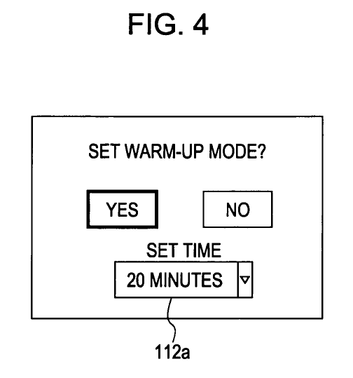

FIG. 4 shows an example of a GUI screen displayed on the display panel 101 when the setting menu of the warm-up mode is selected. The user can perform the setting of the warm-up mode by selecting a button, “Yes”, on the GUI screen in the operation of the user operation section 112. On the other hand, the user can cancel the setting of the warm-up mode by selecting a button, “No”, on the GUI screen.

In addition, by using a time-setting section 112a on the GUI screen in the operation of the user operation section 112, the user can set a time from the setting of the backlight-on state in the warm-up mode to the image-display-on state. For example, the time can be set at 10 minute intervals and up to two hours.

When in Step ST3 it is determined that the warm-up mode is set, in Step ST4 the control section 111 controls the signal output section 117 and sets the image-mute-on state. In this case, the signal output section 117 supplies the panel driver 113 with an image signal used to display a black image. Therefore, the liquid crystal display panel 101 practically does not display an image in the image-mute-on state.

Then, in Step ST5, the control section 111 puts the inverter 114 into an operational state and sets the backlight-on state in which the cold cathode fluorescent lamps 103 in the backlight unit 102 are lighted. In the backlight-on state, the backlight unit 102 illuminates the rear face of the liquid crystal display panel 101.

Then, in Step ST6 the control section 111 determines whether or not the set time has elapsed. When the set time has elapsed, in Step ST7 the control section 111 controls the signal output section 117 so that the image-mute-on state is cancelled and the image-display-on state is set. In the image-mute-off state, since the image signals (R, G, B) processed in the signal processing section 116 are supplied from the signal output section 117 to the panel driver 113, the image-display-on state in which the liquid crystal display panel 101 displays an image is set.

At this time, since the backlight-on state in which the respective cold cathode fluorescent lamps 103 in the backlight unit 102 are lighted is set, an image displayed on the display panel 101 is actually visible unlike in the image-display-on state in Step ST2 mentioned above. After the processing in Step ST7, in Step ST8 the control section 111 shifts to a control operation in a normal on-state.

In addition, when in Step ST3 it is determined that the warm-up mode is not set, the control section 111 shifts to processing in Step ST9. In Step ST9, the control section 111 puts the inverter 114 into an operational state and sets the backlight-on state in which the cold cathode fluorescent lamps 103 in the backlight unit 102 are lighted. In the backlight-on state, the backlight unit 102 illuminates the rear face of the liquid crystal display panel 101. Therefore, the image which the liquid crystal display panel 101 displays in the image-display-on state in Step ST2 becomes actually visible. After the processing in Step ST9, in Step ST8 the control section 111 shifts to the control operation in the normal on-state.

In the liquid crystal display device 100 shown in FIG. 1, when the warm-up mode is set at the time of powering on, the image-display-on state in which the liquid crystal display panel 101 displays an image is set after the elapse of the set time from the setting of the backlight-on state. In the backlight-on state, the liquid crystal display panel 101 is warmed up with heat generated by the lighting of the plurality of cold cathode fluorescent lamps 103 in the backlight unit 102.

Therefore, for example even in a low-temperature environment, after the elapse of the predetermined time from the setting of the backlight-on state, the temperature of the liquid crystal display panel 101 reaches a temperature at which the liquid crystal display panel 101 functions normally. Accordingly, when the image-display-on state is set after the elapse of the predetermined time from the setting of the backlight-on state, a favorable image is displayed and an image is not displayed in a patchy fashion. Therefore, in a season such as winter when the ambient temperature is low, as a result of the user setting the warm-up mode, an image is prevented from being displayed in a patchy fashion.

In the liquid crystal display device 100 shown in FIG. 1, the liquid crystal display panel 101 is warmed up by using heat generated by the lighting of the cold cathode fluorescent lamps 103 in the backlight unit 102. Namely, the liquid crystal display panel 101 is warmed up without a sheet heater used to warm up the liquid crystal display panel 101, the sheet heater being usually arranged between the liquid crystal display panel 101 and the backlight unit 102. Therefore, the structure of the liquid crystal display device 100 can be prevented from becoming complicated. In addition, the cost of the liquid crystal display device and the power consumption thereof do not increase.

In addition, in the liquid crystal display device 100 shown in FIG. 1, when the warm-up mode is not set at the time of powering on, the image-display-on state and the backlight-on state are set immediately. Therefore, in a season, other than winter, when the ambient temperature is high, usually the user does not set the warm-up mode. Therefore, a waiting time before an image is displayed from the time of powering on can be shortened.

In addition, in the liquid crystal display device 100 shown in FIG. 1, for example by using the GUI screen, the user can set the time from the setting of the backlight-on state in the warm-up mode to the image-display-on state. Therefore, the user can arbitrarily set the length of the set time according to the ambient temperature. Accordingly, for example, in a season when the ambient temperature is high, the length of the predetermined time can be set to a short time or zero. Therefore, a waiting time before an image is displayed from the time of powering on can be shortened.

In addition, in the liquid crystal display device 100 shown in FIG. 1, when the warm-up mode is set, the signal output section 117 is controlled after the elapse of the set time from the setting of the backlight-on state, so that the image-mute-off state is set and the image-display-on state is set. Therefore, the liquid crystal display panel 101 shifts to the image-display-on state without setting various settings (such as settings of magnification and filtering) in the signal processing section 116. Therefore, an image which is out of synchronization is prevented from being displayed on the liquid crystal display panel 101.

In addition, in the liquid crystal display device 100 shown in FIG. 1, the backlight unit 102 includes the plurality of cold cathode fluorescent lamps 103. Then, the plurality of cold cathode fluorescent lamps 103 are evenly arranged on the rear face of the crystal display panel 101. Therefore, the whole surface of the liquid crystal display panel 101 can be warmed up efficiently and in a short time with heat generated by the plurality of cold cathode fluorescent lamps 103 in the backlight unit 102.

### 2. Modified Embodiment

In addition, in the above-mentioned embodiment, after the control section 111 sets the image-display-on state in which the liquid crystal display panel 101 displays an image, the control section 111 determines whether or not the warm-up mode is set. However, after the control section 111 determines whether or not the warm-up mode is set, the control section 111 may control the signal processing section 116 and the signal output section 117 at suitable timing. Furthermore, the control section 111 may set the panel driver 113 to an operational state and set the image-display-on state.

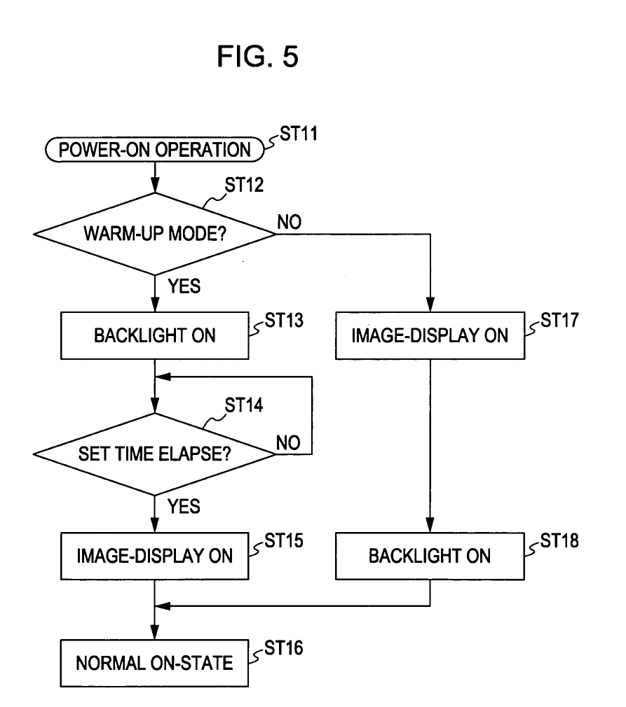

A flowchart shown in FIG. 5 shows another example of a control operation performed at the time of powering on in the control section 111. For example, when the user operation section 112 performs a power-on operation, in Step ST11 the control section 111 starts a control operation and then shifts to processing in Step ST12. In Step ST12, the control section 111 determines whether or not the warm-up mode is set.

When it is determined that the warm-up mode is set, in Step ST13 the control section 111 puts the inverter 114 into an operational state and sets the backlight-on state in which the cold cathode fluorescent lamps 103 in the backlight unit 102 are lighted. In the backlight-on state, the backlight unit 102 illuminates the rear face of the liquid crystal display panel 101.

Next, in Step ST14, the control section 111 determines whether or not the set time has elapsed. When the set time has elapsed, the control section 111 shifts to processing in Step ST15. In Step ST15, the control section 111 controls the signal processing section 116 and the signal output section 117. Furthermore, the control section 111 puts the panel driver 113 into an operational state and sets the image-display-on state. Namely, the control section 111 sets various settings (such as settings of magnification and filtering) in the signal processing section 116. In addition, the control section 111 changes the image-mute from an on-state to an off-state and has an image signal supplied to the panel driver 113, the image signal being output from the processing section 116.

Accordingly, the image-display-on state in which the liquid crystal display panel 101 displays an image is set. At this time, the backlight-on state in which the respective cold cathode fluorescent lamps 103 in the backlight unit 102 are lighted is set. Therefore, an image displayed on the liquid crystal display panel 101 is actually visible. After the processing in the Step ST15, in Step ST16 the control section 111 shifts to a control operation in a normal on-state.

In addition, when in Step ST12 it is not determined that the warm-up mode is set, the control section 111 shifts to processing in Step ST17. In Step ST17, the control section 111 controls the signal processing section 116 and the signal output section 117. Furthermore, the control section 111 puts the panel driver 113 into an operational state and sets the image-display-on state in which the liquid crystal display panel 101 displays an image.

Then, in Step ST18, the control section 111 puts the inverter 114 into an operational state and sets the backlight-on state in which the cold cathode fluorescent lamps 103 in the backlight unit 102 are lighted. In the backlight-on state, the backlight unit 102 illuminates the rear face of the liquid crystal display panel 101. Therefore, an image which the liquid crystal display panel 101 displays becomes visible. After the processing in Step ST18, in Step ST16 the control section 111 shifts to the control operation in the normal on-state.

In the above-mentioned control operation example shown in the flowchart in FIG. 5, when in Step ST15 the image-display-on state is set, the backlight-on state has been set already. Therefore, an image which is out of synchronization may be displayed on the liquid crystal display panel 101, the image being under various settings set in the signal processing section 116 which is out of synchronization. Then, instead of setting the image-display-on state immediately after the elapse of the set time, the backlight section may be put into the backlight-off state once. In such a state, the image-display-on state may be set, and furthermore the backlight-on state may be set again.

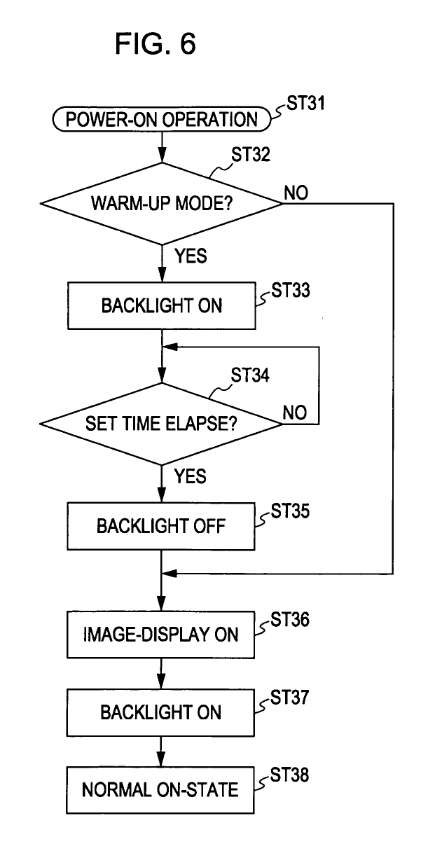

FIG. 6 shows another example of a control operation performed at the time of powering on in the control section 111.

For example, when a power-on operation is performed by using the user operation section 112, the control section 111 starts a control operation in Step ST31. Then, the control operation shifts to processing in Step ST32. In Step ST32, the control section 111 determines whether or not the warm-up mode is set.

When it is determined that the warm-up mode is set, in Step ST33 the control section 111 puts the inverter 114 into an operational state and sets the backlight-on state in which the cold cathode fluorescent lamps 103 in the backlight unit 102 are lighted. In the backlight-on state, the backlight unit 102 illuminates the rear face of the liquid crystal display panel 101.

Next, in Step ST34, the control section 111 determines whether or not the set time has elapsed. When the set time has elapsed, the control section 111 shifts to processing in Step ST35. In Step ST35, the control section 111 puts the inverter 114 into a non-operational state and sets the backlight-off state in which the cold cathode fluorescent lamps 103 are turned off.

In Step ST36, the control section 111 controls the signal processing section 116 and the signal output section 117. Furthermore, the control section 111 puts the panel driver 113 into an operational state and sets the image-display-on state. Namely, the control section 111 sets various settings (such as settings of magnification and filtering) in the signal processing section 116. In addition, the control section 111 changes the image-mute from an on-state to an off-state and has an image signal supplied to the panel driver 113, the image signal being output from the processing section 116. Accordingly, the image-display-on state in which the liquid crystal display panel 101 displays an image is set. However, at this time, since the backlight-off state is set, an image displayed on the liquid crystal display panel 101 is actually invisible.

Next, in Step ST37, the control section 111 puts the inverter 114 into an operational state and sets the backlight-on state in which the cold cathode fluorescent lamps 103 in the backlight unit 102 are lighted. In the backlight-on state, the backlight unit 102 illuminates the rear face of the liquid crystal display panel 101. Therefore, an image which the liquid crystal display panel 101 displays becomes visible. After the processing in Step ST37, in Step ST38 the control section 111 shifts to the control operation in the normal on-state.

In addition, when in Step ST32 it is not determined that the warm-up mode is set, the control section 111 shifts to processing in Step ST36. In Step ST36, the control section 111 controls the signal processing section 116 and the signal output section 117. Furthermore, the control section 111 puts the panel driver 113 into an operational state and sets the image-display-on state in which the liquid crystal display panel 101 displays an image.

Then, in Step ST37, the control section 111 puts the inverter 114 into an operational state and sets the backlight-on state in which the cold cathode fluorescent lamps 103 in the backlight unit 102 are lighted. In the backlight-on state, the backlight unit 102 illuminates the rear face of the liquid crystal display panel 101. Therefore, an image which the liquid crystal display panel 101 displays becomes visible. After the processing in Step ST37, in Step ST38 the control section 111 shifts to the control operation in the normal on-state.

As described above, when the warm-up mode is set by the user operation section 112, the backlight-off state is set once after the elapse of the predetermined time from the setting of the backlight-on state. Then, after that, the image-display-on state is set, and furthermore the backlight-on state is set again. Various settings (such as settings of magnification and filtering) in the signal processing section 116 are set so that the image-display-on state is set. In addition, the signal output section 117 is controlled, so that the image-mute is changed from an on-state to an off-state. However, the backlight-off state is set at this time. Therefore, an image which is out of synchronization is prevented from being displayed on the liquid crystal display panel 101.

In addition, in the above-mentioned embodiment, when the warm-up mode is set at the time of powering on, the image-display-on state in which the liquid crystal display panel 101 displays an image is set after the elapse of the set time from the setting of the backlight-on state. However, instead of setting timing to after the set time, the timing being when the image-display-on state is set after the backlight-on state being set, the timing may be set to a time when the temperature of the liquid crystal display panel 101 may become higher than or equal to a predetermined value. In this case, for example the predetermined value is set to a temperature at which the liquid crystal display panel 101 functions normally.

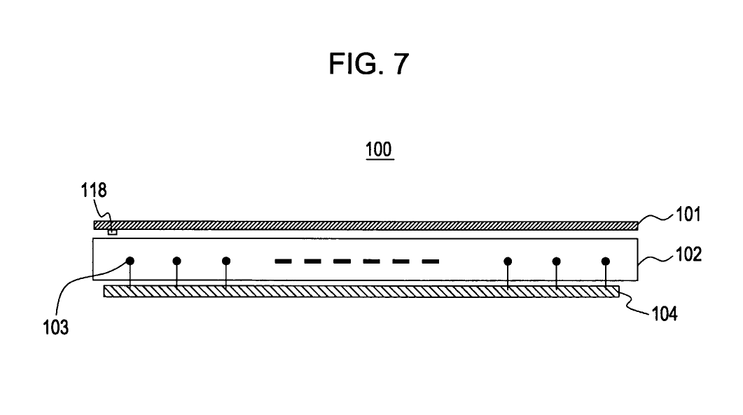

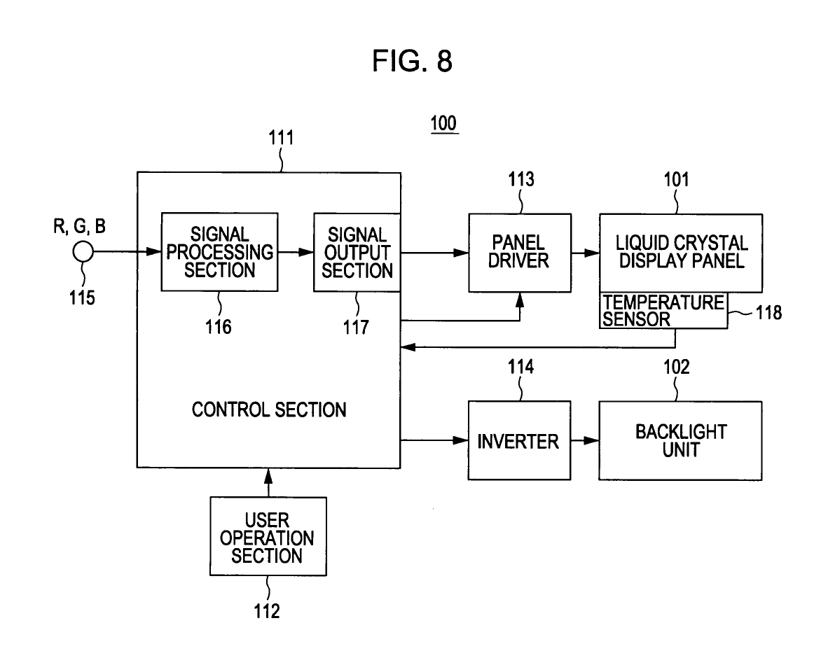

In this case, as shown in FIG. 7, a temperature sensor 118 is provided on the liquid crystal display panel 101. Then, as shown in FIG. 8, a detection signal detected by the temperature sensor 118 is supplied to the control section 111. In FIGS. 7 and 8, the same symbols are assigned to components corresponding to those in FIGS. 1 and 2. In addition, the number of the temperature sensor 118 provided on the liquid crystal display panel 101 is not limited to one. Then, a plurality of temperature sensors may be provided away from one another on the face of the crystal display panel 101.

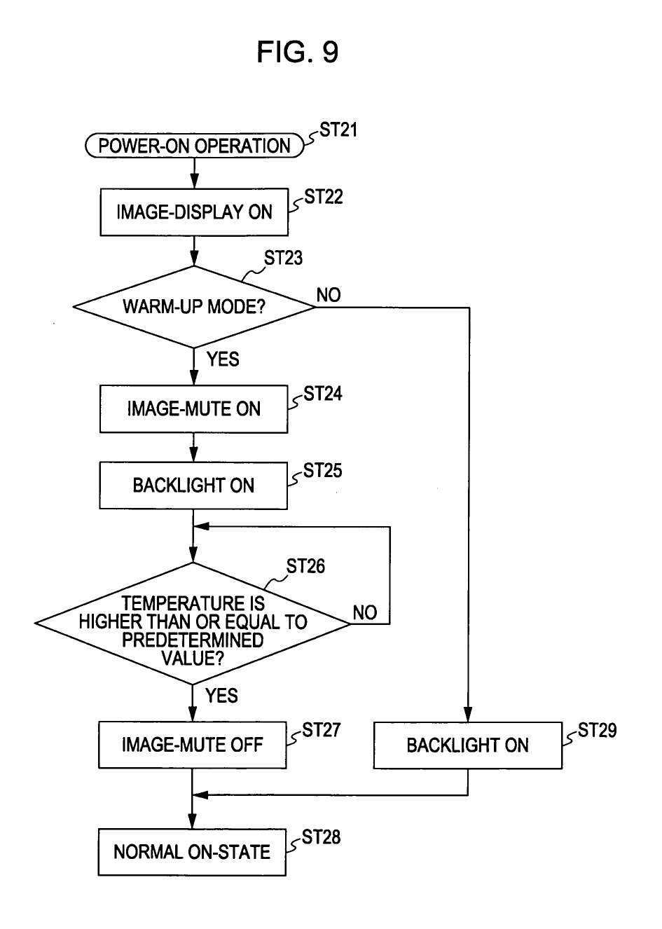

FIG. 9 shows another example of a control operation performed at the time of powering on in the control section 111. For example, when a power-on operation is performed by using the user operation section 112, the control section 111 starts a control operation in Step ST21. Then, the control operation shifts to processing in Step ST22. In Step ST22, the control section 111 controls the signal processing section 116 and the signal output section 117. Furthermore, the control section 111 puts the panel driver 113 into an operational state and sets the image-display-on state in which the liquid crystal display panel 101 displays an image. However, at this time, the backlight-on state in which the respective cold cathode fluorescent lamps 103 in the backlight unit 102 are lighted is not set. Therefore, an image displayed on the liquid crystal display panel 101 is actually invisible.

Next, in Step ST23, the control section 111 determines whether or not the warm-up mode is set. When it is determined that the warm-up mode is set, in Step ST24 the control section 111 controls the signal output section 117 and sets the image-mute-on state. In this case, the signal output section 117 supplies the panel driver 113 with an image signal used to display a black image. Therefore, the liquid crystal display panel 101 practically does not display an image in the image-mute-on state.

Then, in Step ST25, the control section 111 puts the inverter 114 into an operational state and sets the backlight-on state in which the cold cathode fluorescent lamps 103 in the backlight unit 102 are lighted. In the backlight-on state, the backlight unit 102 illuminates the rear face of the liquid crystal display panel 101.

Then, in Step ST26, on the basis of the detection signal detected by the temperature sensor 118, the control section 111 determines whether or not the temperature of the liquid crystal display panel 101 is higher than or equal to the predetermined value. When the plurality of temperature sensors 118 are provided on the face of the liquid crystal display panel 101, the control section 111 determines whether or not the temperatures which all detection signals of the plurality of temperature sensors 118 indicate are higher than or equal to the predetermined value.

When the temperature of the liquid crystal display panel 101 is higher than or equal to the predetermined value, in Step ST27 the control section 111 controls the signal output section 117 so that the image-mute-on state is cancelled and the image-display-on state is set. In the image-mute-off state, since the image signals (R, G, B) processed in the signal processing section 116 are supplied from the signal output section 117 to the panel driver 113, the image-display-on state in which the liquid crystal display panel 101 displays an image is set.

At this time, since the backlight-on state in which the respective cold cathode fluorescent lamps 103 in the backlight unit 102 are lighted is set, an image displayed on the display panel 101 is actually visible unlike in the image-display-on state in Step ST22 mentioned above. After the processing in the Step ST27, in Step ST28 the control section 111 shifts to a control operation in a normal on-state.

In addition, when in Step ST23 it is not determined that the warm-up mode is set, the control section 111 shifts to processing in Step ST29. In Step ST29, the control section 111 puts the inverter 114 into an operational state and sets the backlight-on state in which the cold cathode fluorescent lamps 103 in the backlight unit 102 are lighted. In the backlight-on state, the backlight unit 102 illuminates the rear face of the liquid crystal display panel 101. Therefore, the image which the liquid crystal display panel 101 displays in the image-display-on state in Step ST22 becomes visible actually. After the processing in Step ST29, in Step ST28 the control section 111 shifts to the control operation in the normal on-state.

As described above, in the case that the image-display-on state is set at the timing when the temperature of the liquid crystal display panel 101 becomes higher than or equal to the predetermined value after the backlight-on state is set, for example there are advantageous effects as follows. Namely, when a temperature at which the liquid crystal display panel functions normally is set as the predetermined value, the temperature of the crystal display panel reaches the temperature, at which the liquid crystal display panel can function normally, at the time when the image-display-on state is set. Therefore, at the time when the image-display-on state is set, a favorable image is displayed on the liquid crystal display panel while an image is not displayed in a patchy fashion. In addition, in the case that the image-display-on state is set at the timing when the temperature of the liquid crystal display panel becomes higher than or equal to the predetermined value after the backlight-on state is set, a useless waiting time can be eliminated.

In addition, in the above-mentioned embodiment, it is described that a power-on operation is performed by using the user operation section 112 for example. For example, as the power-on operation, there are various types of power-on operations as shown in items (a) to (e).

(a) power button used for a main body

(b) power button used for a remote-control unit

(c) remote control (control via a RS-232C communication or a LAN)

(d) a timer

(e) AC power-on (if AC power-off is performed in a power-on state, next AC power-on causes a power-on state to be set.)

While items (a), (b), (c), and (e) correspond to an external control, item (d) corresponds to an on-off control linked to an internal timer. As described above, when there are various types of power-on operations, one of a first warm-up mode and a second warm-up mode may be set as the warm-up mode, as hereafter described.

Here, the first warm-up mode is a warm-up mode available upon powering-on performed by any one of the various types of power-on operations. In addition, the second warm-up mode is a warm-up mode available upon powering-on performed by a specific one of the various types of power-on operations. For example, the second warm-up mode is a warm-up mode available upon powering-on performed by a power-on operation based on the timer.

In this case, when the first warm-up mode is set, first the backlight-on state is set upon powering-on performed by any one of the various types of power-on operations. Then, the image-display-on state can be set after the elapse of the predetermined time from the setting of the backlight-on state. In addition, when the second warm-up mode is set, first the backlight-on state is set upon powering-on performed by a specific one, such as a power-on operation based on the timer for example, of the various types of power-on operations. Then, the image-display-on state can be set after the elapse of the predetermined time from the setting of the backlight-on state.

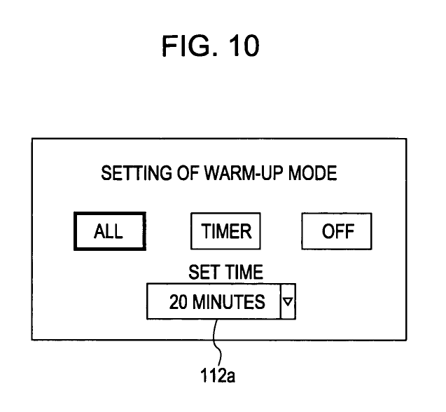

When, as described above, the first warm-up mode and the second warm-up mode are provided as the warm-up mode, the user can set the warm-up mode in advance by using the setting menu, also. FIG. 10 shows an example of a GUI screen displayed on the liquid crystal display panel 101 when the setting menu of the warm-up mode is selected.

For example, the user can perform the setting of the first warm-up mode by selecting a button, “ALL”, on the GUI screen in the operation of the user operation section 112. In addition, the user can perform the setting of the second warm-up mode by selecting a button, “Timer”, on the GUI screen. Then, the example of the GUI screen shown in FIG. 10 shows the case that the specific power-on operation corresponding to the second warm-up mode is based on the timer. In addition, the user can cancel the setting of the warm-up mode by selecting a button, “OFF”, on the GUI screen.

In addition, for example, by using a time-setting section 112a on the GUI screen in the operation of the user operation section 112, the user can set a time from the setting of the backlight-on state in the first warm-up mode and the second warm-up mode to the image-display-on state. For example, the time can be set at 10 minutes intervals and up to two hours.

In addition, the above-mentioned embodiment shows the case that on powering-on the control section 111 determines whether or not the warm-up mode is set and performs a different type of control operation on the basis of whether or not the warm-up mode is set. However, the control section 111 may perform at any time the same control operation as in the warm-up mode, without the determination step used to determine whether or not the warm-up mode is set.

In addition, in the above-mentioned embodiment, the backlight unit 102 includes the plurality of cold cathode fluorescent lamps 103. However, a light source including the backlight unit 102 is not limited to the cold cathode fluorescent lamps 103. Then, a structure which includes another light source may be used. In this regard, it is desirable that the lighting of the light source generates a certain amount of heat.

The present application contains subject matter related to that disclosed in Japanese Priority Patent Application JP 2009-060445 filed in the Japan Patent Office on Mar. 13, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display device comprising:
a liquid crystal display panel;
a panel-driving section configured to drive the liquid crystal display panel so that the liquid crystal display panel displays an image;
a backlight section configured to be arranged on the rear face of the liquid crystal display panel;
a backlight-driving section configured to drive the backlight section so that the backlight section illuminates the liquid crystal panel from the rear face; and
a control section configured to control the operations of the panel-driving section and the backlight-driving section;
wherein when the liquid crystal display device is powered on, the control section controls the backlight-driving section so that the backlight section is put into a backlight-on state in which the backlight section illuminates the liquid crystal panel from the rear face; and
after the elapse of a predetermined time from the setting of the backlight-on state, the control section controls the panel-driving section so that the liquid crystal display panel is put into an image-display-on state in which the liquid crystal display panel displays the image.

2. The liquid crystal display device according to claim 1, further comprising:
a user operation section configured to be used by a user so as to set a warm-up mode,
wherein when the warm-up mode is set by the user operation section upon powering on, the control section controls the backlight-driving section so that the backlight section is put into the backlight-on state in which the backlight section illuminates the liquid crystal panel from the rear face; and
after the elapse of the predetermined time from the setting of the backlight-on state, the control section controls the panel-driving section so that the liquid crystal display panel is put into the image-display-on state in which the liquid crystal display panel displays the image.

3. The liquid crystal display device according to claim 2, wherein
when the warm-up mode is not set by the user operation section upon powering on, the control section controls the panel-driving section so that the liquid crystal display panel is put into the image-display-on state, in which the liquid crystal display panel displays the image, and controls the backlight-driving section so that the backlight section is put into the backlight-on state in which the backlight section illuminates the liquid crystal panel from the rear face.

4. The liquid crystal display device according to claim 3, wherein
after on powering-on the control section controls the panel-driving section so that the liquid crystal display panel is put into the image-display-on state in which the liquid crystal display panel displays the image, the control section determines whether or not the warm-up mode is set by the user operation section;
when the warm-up mode is set by the user operation section, the control section controls the panel-driving section so that the liquid crystal display panel is put into an image-mute-on state in which the liquid crystal display panel does not display the image before controlling the backlight-driving section so that the backlight section is put into the backlight-on state in which the backlight section illuminates the liquid crystal panel from the rear face;
after the elapse of the predetermined time from the setting of the backlight-on state, the control section controls the panel-driving section so that the image-mute-on state is cancelled and the liquid crystal display panel is put into the image-display-on state in which the liquid crystal display panel displays the image; and
when the warm-up mode is not set by the user operation section, the control section controls the backlight-driving section so that the backlight section is put into the backlight-on state in which the backlight section illuminates the liquid crystal panel from the rear face.

5. The liquid crystal display device according to claim 3, wherein
when the warm-up mode is set by the user operation section upon powering on,
after the elapse of the predetermined time from the setting of the backlight-on state, the control section controls the backlight-driving section so that the backlight section is put into the backlight-off state in which the backlight section does not illuminate the liquid crystal panel before controlling the panel-driving section so that the liquid crystal display panel is put into the image-display-on state in which the liquid crystal display panel displays the image; and
after the control section controls the panel-driving section so that the liquid crystal display panel is put into the image-display-on state in which the liquid crystal display panel displays the image, the control section controls the backlight-driving section so that the backlight section is put into the backlight-on state in which the backlight section illuminates the liquid crystal panel from the rear face.

6. The liquid crystal display device according to claim 2, wherein
the liquid crystal display device is put into a power-on state by various types of power-on operations; and
the warm-up mode set by the user operation section is a first warm-up mode available upon powering-on performed by any one of the various types of power-on operations or a second warm-up mode available upon powering-on performed by a specific one of the various types of power-on operations.

7. The liquid crystal display device according to claim 1, further comprising:
a user operation section configured to be used by a user so as to set the predetermined time.

8. The liquid crystal display device according to claim 1, wherein
the backlight section includes a plurality of fluorescent tubes; and
the plurality of fluorescent tubes are evenly arranged on the rear face of the liquid crystal display panel.

9. The liquid crystal display device according to claim 1, further comprising:
a temperature sensor configured to detect the temperature of the liquid crystal display panel,
wherein the predetermined time is a time it takes from the setting of the backlight-on state for the temperature of the liquid crystal display panel to become higher than or equal to a predetermined value, the temperature being detected by the temperature sensor.

10. A method of controlling powering on of a liquid crystal display device, the liquid crystal display device including
a liquid crystal display panel;
a panel-driving section configured to drive the liquid crystal display panel so that the liquid crystal display panel displays an image;
a backlight section configured to be arranged on the rear face of the liquid crystal display panel; and
a backlight-driving section configured to drive the backlight section so that the backlight section illuminates the liquid crystal panel from the rear face;
the method comprising the steps of:
controlling the backlight-driving section so that the backlight section is put into a backlight-on state in which the backlight section illuminates the liquid crystal panel from the rear face; and
controlling, after the elapse of a predetermined time from the setting of the backlight-on state, the panel-driving section so that the liquid crystal display panel is put into an image-display-on state in which the liquid crystal display panel displays the image.
